(19) United States
(12) Patent Application Publication
(10) Pub. No.: US 2025/0293305 A1
(43) Pub. Date: Sep. 18, 2025

(54) POLYVALENT METAL ION-CONTAINING ELECTROLYTE FOR RECHARGEABLE BATTERY

(71) Applicants: Saudi Arabian Oil Company, Dhahran (SA); King Abdullah University of Science and Technology, Thuwal (SA)

(72) Inventors: Husam Niman Alshareef, Thuwal (SA); Zhiming Zhao, Thuwal (SA); Jehad Khaled El-Demellawi, Thuwal (SA)

(21) Appl. No.: 18/602,990

(22) Filed: Mar. 12, 2024

(51) Int. Cl. H01M 10/0568; H01M 4/131; H01M 4/505; H01M 4/525; H01M 10/0569

(52) U.S. Cl. CPC H01M 10/0568; H01M 4/131; H01M 4/505; H01M 4/525; H01M 10/0569; H01M 2300/0037

(57) ABSTRACT

An electrochemical cell for a rechargeable battery, where the electrochemical cell includes: an anode including lithium (Li); an anode current collector connected to the anode; a cathode; a cathode current collector connected to the cathode; a separator between the anode and the cathode; and a liquid electrolyte including: a solvent, a Li salt dissolved in the solvent, and a polyvalent metal salt dissolved in the solvent.

### TECHNICAL FIELD

This disclosure relates to polyvalent metal ion-containing electrolyte compositions for a rechargeable battery.

### BACKGROUND

Energy storage is increasingly demanded in the deployment of renewable energy resources and the improvement of the electrical grid reliability and efficiency. It is considered a critical enabler to the transformation from the current fossil economy to a zero-carbon one. Rechargeable batteries play an important role in energy storage, for example, electric vehicles and portable electronic devices. To further promote sustainable practices and drive the energy transition, continued research and development of rechargeable batteries is needed to improve energy density, cycle life, and scalability among others at reasonable materials and production costs.

### SUMMARY

This disclosure describes technologies relating to polyvalent metal ion-containing electrolyte compositions for a rechargeable battery. In an implementation, an electrochemical cell for a rechargeable battery includes: an anode including lithium (Li); an anode current collector connected to the anode; a cathode; a cathode current collector connected to the cathode; a separator between the anode and the cathode; and a liquid electrolyte including: a solvent, a Li salt dissolved in the solvent, and a polyvalent metal salt dissolved in the solvent.

### BRIEF DESCRIPTION OF DRAWINGS

FIG. 1 shows an example lithium (Li) battery electrochemical cell of this disclosure.

FIGS. 2 and 3 show molecular structures of example carbonate solvents for an electrolyte, wherein FIG. 2 is ethylene carbonate (EC) and FIG. 3 is diethyl carbonate (DEC).

FIG. 4 shows a molecular structure of lithium hexafluorophosphate (LiPF₆).

FIG. 5 shows a molecular structure of magnesium bis(trifluoromethanesulfonyl)imide (Mg(TFSI)₂).

FIG. 6 shows Coulombic efficiency results of battery cell tests with a magnesiated electrolyte for a lithium-copper (Li∥Cu) cell system,

FIG. 7 shows cycling performance results of battery cell tests with a magnesiated electrolyte for a symmetrical Li cell.

FIGS. 8-13 show results of battery cell tests with a magnesiated electrolyte for a 100 μm Li∥Li-transition metal oxide cell system, wherein FIG. 8 shows cycling performance, FIG. 9 shows charge-discharge voltage curves with a reference electrolyte, FIG. 10 shows charge-discharge voltage curves with the magnesiated electrolyte, FIG. 11 shows charging voltage curves, FIG. 12 shows rate performance with the magnesiated electrolyte, and FIG. 13 shows rate performance with the reference electrolyte.

FIGS. 14-16 show results of battery cell tests with a magnesiated electrolyte for a 50 μm Li∥Li-transition metal oxide cell system, wherein FIG. 14 shows cycling performance, FIG. 15 shows charge-discharge voltage curves with a reference electrolyte, and FIG. 16 shows charge-discharge voltage curves with the magnesiated electrolyte.

FIGS. 17-19 show results of battery cell tests with a magnesiated electrolyte for a graphite∥Li-transition metal oxide cell system, wherein FIG. 17 shows cycling performance, FIG. 18 shows charge-discharge voltage curves with a reference electrolyte, and FIG. 19 shows charge-discharge voltage curves with the magnesiated electrolyte.

FIGS. 20 and 21 show results of battery cell tests with an electrolyte including an aluminum additive for a 100 μm Li∥Li-transition metal oxide cell system, wherein FIG. 20 shows cycling performance and FIG. 21 shows charge-discharge voltage curves with the Al-containing electrolyte.

### DETAILED DESCRIPTION

Implementations described herein provide polyvalent metal ion-containing electrolyte compositions for a rechargeable battery. In some implementations, the electrolyte compositions offer improvements in battery performance, e.g., Coulombic efficiency (CE) and stability, particularly in Li-metal battery. Li-based batteries, both Li-ion and Li-metal batteries, generally offer numerous advantages, including high energy density, long cycle life, and fast charging capabilities. While Li-metal batteries can potentially have better energy density than Li-ion batteries, the challenges in Li-metal batteries include limited cycle life and loss of capacity due to Li depletion and pulverization. The polyvalent metal ion-containing electrolyte described in this disclosure can mitigate these issues by protecting the electrodes without compromising the Li ion transport.

In various implementations, the rechargeable batteries having the polyvalent metal ion-containing electrolyte can be applied in the oil and gas sector. With the improved battery performance, the implementations can enhance the efficiency and reliability of various applications, such as remote monitoring systems, pipeline inspection tools, seismic exploration, and off-grid power solutions. These batteries can provide reliable power for remote locations, enable continuous monitoring of critical parameters, and support the integration of renewable energy sources.

Specifically, the electrolyte in this disclosure can include, for example, a carbonate solvent, a Li species, and polyvalent metal cations such as magnesium ions (Mg²⁺) with Lewis acidity higher than lithium ions (Li⁺). Generally, the electrolyte is a vital component of a battery cell that straddles the anode and the cathode. It serves as a conduit for ion transport whilst simultaneously blocking electron transmission. During battery operation, the electrolyte is subjected to and must withstand the aggressive reducing and oxidizing conditions imposed by the electrodes. Consequently, the functional efficiency of a successful battery essentially pivots on the interphases established between the electrode and the electrolyte.

In Li-metal/ion batteries, a stable solid-electrolyte interphase (SEI) and a cathode-electrolyte interphase (CEI) can be formed on the anode and the cathode surfaces, respectively. These surface films typically comprise organic components, e.g., alkyl carbonates derived from solvent decomposition and inorganic constituents e.g., lithium fluoride (LiF) and lithium carbonate (Li₂CO₃), stemming from anion decomposition.

The addition of the polyvalent metal cation such as Mg²⁺ in the electrolyte described in this disclosure can improve the formation of a robust SEI to protect the Li anode without blocking Li⁺ passage through the SEI. Further, a CEI can also be formed and protect the cathode as well.

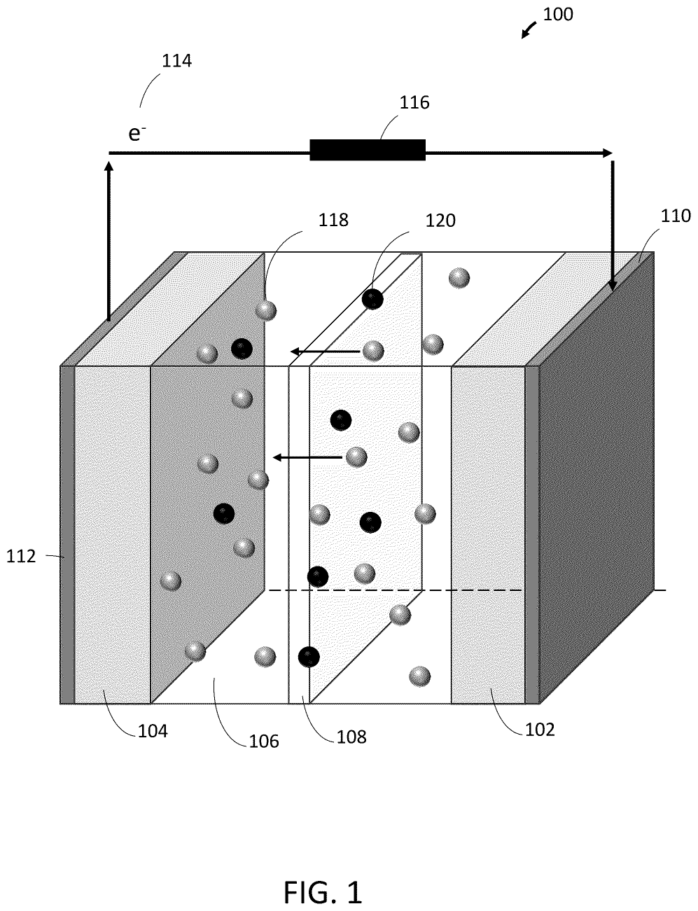

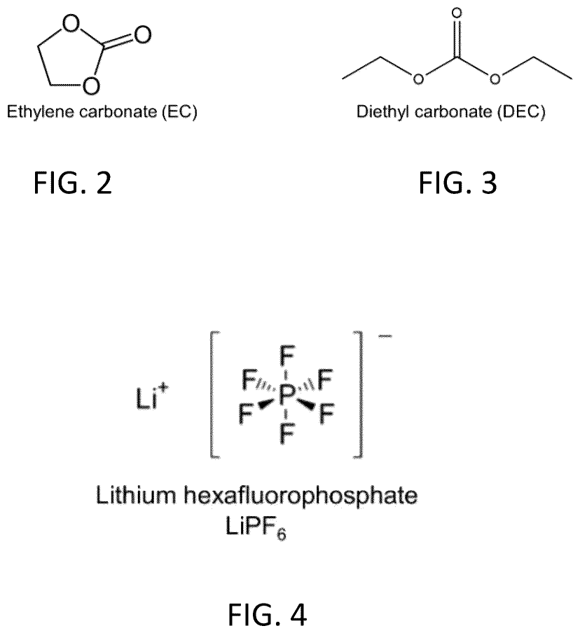

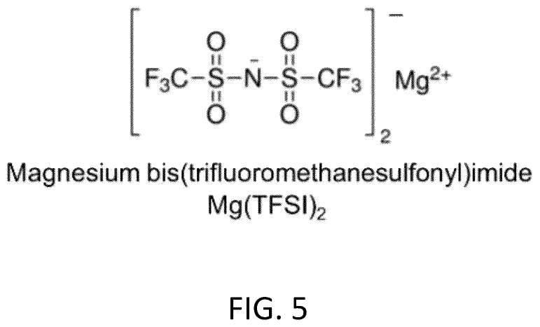

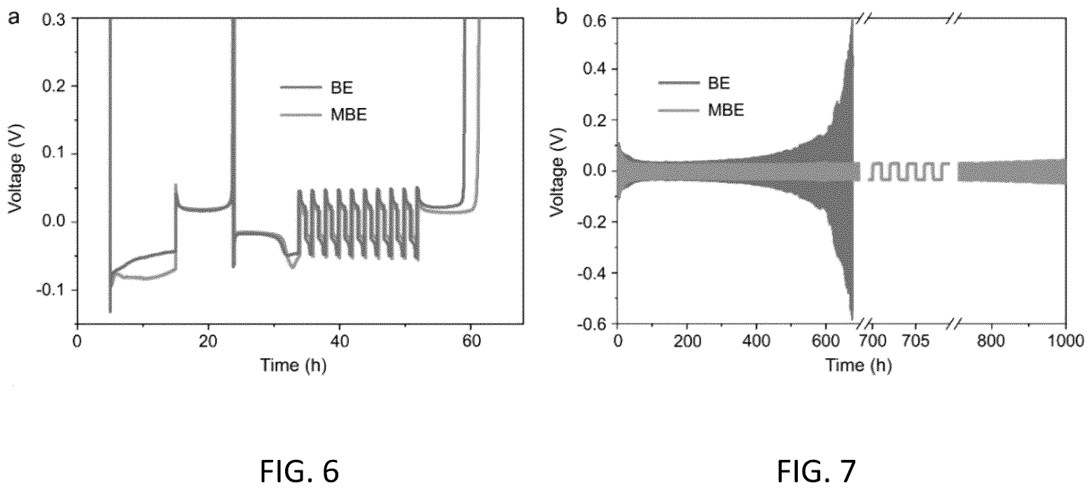

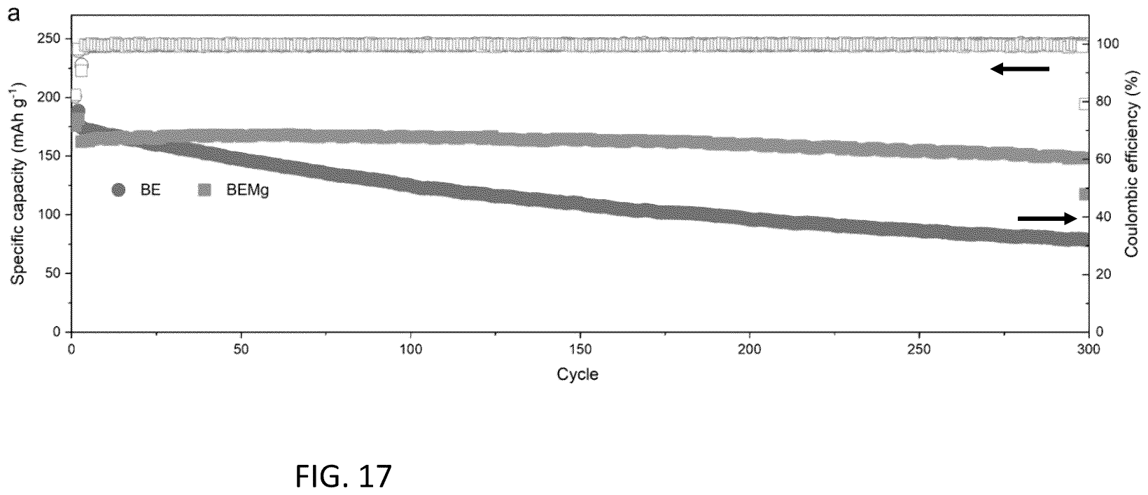

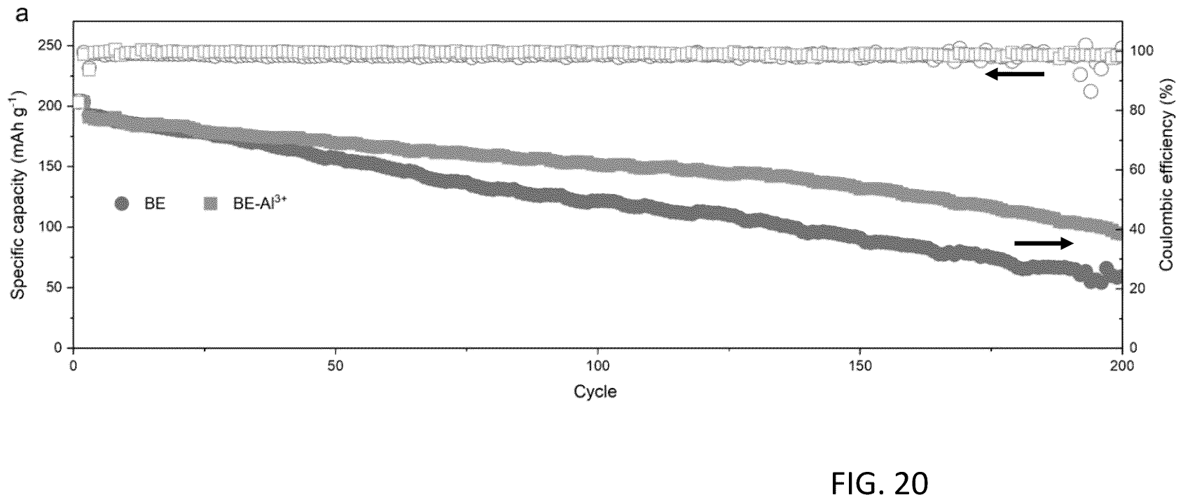

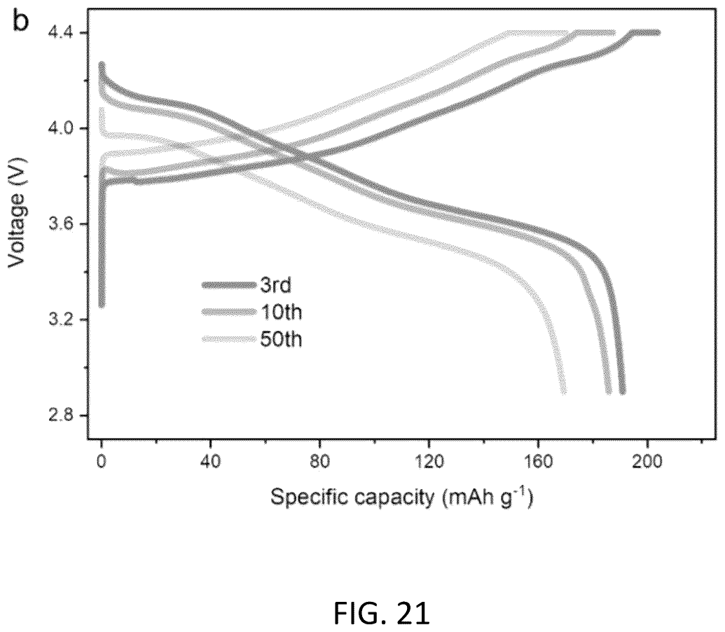

In the following, a battery cell design is first described referring to FIG. 1. Components of the polyvalent metal ion-containing electrolyte are then described referring to FIGS. 2-5. Experimental results of battery performance tests in Li-metal battery systems using the polyvalent metal ion-containing electrolyte are described in FIGS. 6-16. Experimental results of battery performance tests in a Li-ion battery system are then described in FIGS. 17-19. An example of non-magnesium polyvalent metal ions is described in FIGS. 20-21. In this disclosure, the polyvalent metal ion-containing electrolyte can also be referred to as a magnesiated electrolyte when Mg²⁺ is used for the polyvalent metal ion. However, in various implementations, as further described below, one or more polyvalent metal ions are used in place of or in addition to Mg2+.

### Lithium Rechargeable Battery Cell

In FIG. 1, a rechargeable battery cell 100 includes an anode 102, a cathode 104, and an electrolyte 106 that transport charges between the two electrodes. The rechargeable battery cell 100 can further include a separator 108 positioned between the two electrodes, an anode current collector 110 connected to the anode 102, and a cathode current collector 112 connected to the cathode 104.

The separator 108 can be made of a fine porous polymer film such as polypropylene, polyethylene film, fabric film of cellulose, paper, and glass fiber. The film materials for the separator 108 can allow lithium ions to pass through the film while electrically insulating the two electrodes.

In FIG. 1, the rechargeable battery cell 100 is in charging state, where electrons 114 flow from a charger 116 to the anode 102 and from the cathode 104 to the charger 116. The flow of the electrons 114 during discharge will be in an opposite direction.

In various implementations, the rechargeable battery cell 100 is a Li-based battery such as a Li-metal battery or a Li-ion battery. For example, the anode 102 can be Li metal in the case of a Li-metal battery or graphite in the case of a Li-ion battery. In some implementations, in the case of a Li-ion battery, the materials for the anode 102 include silicon, silicon/carbon composite, or lithium titanate.

Cathode materials, on the other hand, can include various Li-based oxide materials, c.g., lithium cobalt oxide (LiCoO₂), lithium iron phosphate (LiFePO₄), lithium manganese oxide (LiMn₂O₄), lithium nickel cobalt aluminum oxide (LiNiCoAlO₂), lithium nickel manganese cobalt oxide (LiNiMnCoO₂), or lithium vanadium oxide (LiV₂O₅). In some implementations, in the case of a Li-metal battery, the cathode 104 can include sulfur (S), selenium (Se), tellurium (Te), or fluorinated carbon. In one implementation, the cathode 104 is a nickel-rich lithium nickel cobalt manganese oxide with a formula of LiNi_{0.8}Co_{0.1}Mn_{0.1}O₂ (NCM811).

Conductive materials can be used for the anode current collector 110 and the cathode current collector 112. In some implementations, copper (Cu) or aluminum (Al) is used for the anode current collector 110, the cathode current collector 112, or both.

In various implementations, the electrolyte 106 includes Li ions (Li⁺) 118 and polyvalent metal ions 120. The polyvalent metal ions 120 can have Lewis acidity higher than Li⁺. The chemical composition of the electrolyte 106 will be further described below.

### Polyvalent Metal Ion-Containing Electrolyte

In various implementations, the polyvalent metal ion-containing electrolyte is a liquid electrolyte using one or more aprotic carbonate solvents. Examples of aprotic carbonate solvents include, but are not limited to, ethylene carbonate (EC) (FIG. 2), dimethyl carbonate (DMC), diethyl carbonate (DEC) (FIG. 3), and propylene carbonate (PC). In one implementation, the solvent is a mixture of EC and DEC. Other types of solvents such as sulfone and nitrile can also be used. In general, the solvent can help dissolve a lithium salt to form a Li-containing liquid electrolyte and enable ion transport in the battery cell. In some implementations, the solvent can be selected such that the solvent composition will not de-solvate the polyvalent metal ions at or near the anode, so further that the polyvalent metal ions cannot be reduced on the anode. Although not wishing to be limited by any theory, the solvated, stable metal ions can catalyze an anion decomposition and facilitate the formation of protective solid-electrolyte interphase (SEI).

In various implementations, one or more lithium salts are used to provide the Li component in the electrolyte. Examples of lithium salts include lithium hexafluorophosphate (LiPF₆) (FIG. 4), lithium tetrafluoroborate (LiBF₄), lithium perchlorate (LiClO₄), lithium bis(fluorosulfonyl)imide (LiFSI), and lithium bis(trifluoromethanesulfonyl)imide (LiTFSI). The concentration of the lithium salt in the electrolyte can be between about 0.1 M and about 5 M. In some implementations, the lithium salt concentration is between about 0.5 M and about 1.5 M.

In general, a popular lithium electrolyte composition uses a relatively high concentration of the lithium salt, e.g., 3 M or higher, to make ionic clusters for superconcentrated or high-concentration electrolytes (HCEs). Such high concentrations may offer protective effects on the electrodes, effectively mitigating undesired phenomena such as Li depletion and pulverization. However, it concurrently introduces substantial cost increase and faces persistent challenges such as increased cell thickness and the pulverization of Li metal after prolonged cycling periods. The polyvalent metal ion-containing electrolyte of the present disclosure, on the other hand, can realize the formation of ionic clusters at a relatively lower concentration due to the affinity between polyvalent ion and anions, c.g., about 1 M or less, thereby overcoming these issues without relying on complex strategies of superconcentrated or HCEs. In some implementations, the lithium salt concentration is between about 50 mM and 1 M.

The polyvalent metal ions can be included in the electrolyte by dissolving one or more polyvalent metal salts in the solvent in addition to Li component. Metal cations for the polyvalent metal salt can include magnesium (Mg²⁺), aluminum (Al³⁺), calcium (Ca²⁺), scandium (Sc³⁺), zinc (Zn²⁺), or gallium (Ga³⁺). In some implementations, a solid-electrolyte interface (SEI) can be formed due to the preferential reduction of anions from the ionic clusters surrounding polyvalent ions. The preferential reduction of anions is due to the lower LUMO energy level of ionic clusters. The SEI can serve as protective layers both on the anode, e.g., Li-metal, and the cathode, e.g., lithium-nickel-containing oxide.

In one implementation, the criteria for the polyvalent metal cations include: (1) the ability to remain solvated in the solvent and not to be reduced on or near the anode; and (2) Lewis acidity higher than Li⁺ ion. The pronounced Lewis acidity of polyvalent metal ions, c.g., Mg²⁺, can foster the formation of potent ionic or covalent bonds between the polyvalent metal ions and the anions and solvents present in the electrolyte. Consequently, the assembly of large aggregates with reduced lowest unoccupied molecular orbital (LUMO) energy levels can take place, ultimately instigating the development of a robust interphase on the anode surface. In principle, divalent or trivalent ions, c.g., Mg²⁺ and Al³⁺, may encounter substantial hindrances in traversing this interphase, primarily due to their high charge density and extensive solvation, which impedes facile desolvation. Further, the rate of ligand exchange for polyvalent metal ions can be merely about one third of that for Li⁺ ions in both liquid and solid systems, culminating in sluggish kinetics for interfacial electrochemistry involving polyvalent metal ions. These differences between the polyvalent metal ions and Li⁺ ions in the charge density and extensive solvation can help overcoming the trade-off between the effective formation of a protective SEI and their negative impact on Li⁺ transport through the SEI. With the protective SEI formation facilitated by the polyvalent metal ions, the electrodes can be better protected without hindering the Li⁺ transport. However, when the two criteria for the metal cations described above are not met, it is possible that the polyvalent metal cations will be reduced and forms an alloy, c.g., lithium magnesium (LiMg), which may prevent the formation of a protective SEI.

An example of the anion for the polyvalent metal salt is bis(trifluoromethanesulfonyl)imide (TFSI). In some implementations, accordingly, the polyvalent metal salt is Mg(TFSI)₂, Al(TFSI)₃, Ca(TFSI)₂, Sc(TFSI)₃, Zn(TFSI)₂, or Ga(TFSI)₃. In one implementation, the anion is an imide or other N-containing species. Examples of the anion for the polyvalent metal salt further include hexafluorophosphate anion, tetrafluoroborate anion, trifluoromethanesulfonate anion, fluorosulfonate anion, bis(fluorosulfonyl)imide anion, (trifluoromethanesulfonyl)(fluorosulfonyl)imide anion, bis(difluorophosphonyl)imide anion, (difluorophosphonyl)(fluorosulfonyl)imide anion, and (difluorophosphonyl)(trifluoromethanesulfonyl)imide anion. The anion can include fluorine, nitrogen, boron, or any combination of them. These ions can facilitate the formation of LiF, or lithium nitride (Li₃N), or boron-containing species in the SEI. The concentration of the polyvalent metal salt in the electrolyte can be between about 2 mM and about 0.5 M. In some implementations, the polyvalent metal salt concentration is between about 5 mM and about 50 mM. Compared to the concentration of the lithium salt, only a small amount of the polyvalent metal salt is needed for the effective electrolyte. For example, the molar ratio of the lithium salt to the polyvalent metal salt can be between 500:1 and 2:1.

In some implementations, the polyvalent metal ion-containing electrolyte include only the solvent, the dissolved lithium salts, and the dissolved polyvalent metal salts, and does not need to include other additives for its effectiveness. In one implementation, the polyvalent metal ion-containing electrolyte is free of silicon species or ketone species that may be used commonly in Li-based electrolytes. Accordingly, the effective Li-based electrolyte composition can be simplified and its preparation can be less costly.

In one implementation, two or more types of polyvalent metal ion salts are used for the electrolyte. For example, Mg(TFSI)₂ and Al(TFSI)₃ can be used together to facilitate the formation of high-entropy interphase and correspondingly foster ion diffusion across the interphase.

### Example 1: Li-Metal Battery System (Anode Study)

The effectiveness of the polyvalent metal ion-containing electrolyte was experimentally demonstrated through battery cell tests. Specifically, Coulombic efficiency (CE) measurements and cycling battery performance tests were conducted. A benchmark electrolyte without any addition of polyvalent metal ions, referred to as BE, and a magnesiated electrolyte containing Mg²⁺ ions, referred to as MBE, was prepared and compared in the battery cell tests to examine the effect of the polyvalent metal ions. The BE contained 1 M LiPF₆ in EC:DEC (1:1, v/v) solvent mixture. The MBE was prepared using the BE by dissolving Mg(TFSI)₂ in the BE to have 20 mM of Mg²⁺ ions in addition to the Li species.

First, as an example for a Li-metal battery, the BE and MBE were tested in a lithium-copper (Li∥Cu) cell system. FIG. 6 shows Coulombic efficiency (CE) results, calculated based on the modified Aurbach's methodology. A high average CE of about 96.23% and a reduced polarization voltage, except for the initial Li nucleation process, were obtained using the MBE, corresponding to reversible Li⁺ deposition/dissolution on the Cu substrate. In contrast, the CE with the BE was only about 85.87%. These results suggest that Li-metal battery cells incorporating the polyvalent metal ions in the electrolyte can exhibit a better long-term stability with improved energy efficiency compared to the Li-alone counterpart, e.g., LiPF₆ alone.

Second, the two electrolytes, BE and MBE, were examined in a symmetrical Li cell under galvanostatic conditions. FIG. 7 shows cycling performance results. Under the galvanostatic conditions, the continuous transition between Li⁰ and Li⁺states was enabled, which can help distinguishing the characteristics of the anode from those of the cathodes. In FIG. 7, the symmetrical Li cell employing the MBE was able to reach stable cycling over 1000 h at a current density of about 0.5 mA·cm⁻², while its counterpart with the BE exhibited a rise in polarization voltage after only 400 h of cycling, demonstrating the improved longevity of the battery cell and the Li-metal anode using the polyvalent metal ion-containing electrolyte.

### Example 2: Li-Metal Battery System (Cathode Study)

Further experiments were conducted to evaluate the oxidation stability of the polyvalent metal ion-containing electrolyte and its compatibility with a nickel-rich cathode. The same set of two electrolytes, BE and MBE, were used for the battery tests in a Li∥Li-transition metal oxide cell system. A nickel-rich cathode having a chemical formula with LiNi_{0.8}Co_{0.1}Mn_{0.1}O₂ (NCM811) was used. Experiments were conducted with a cut-off voltage of 5.5 V.

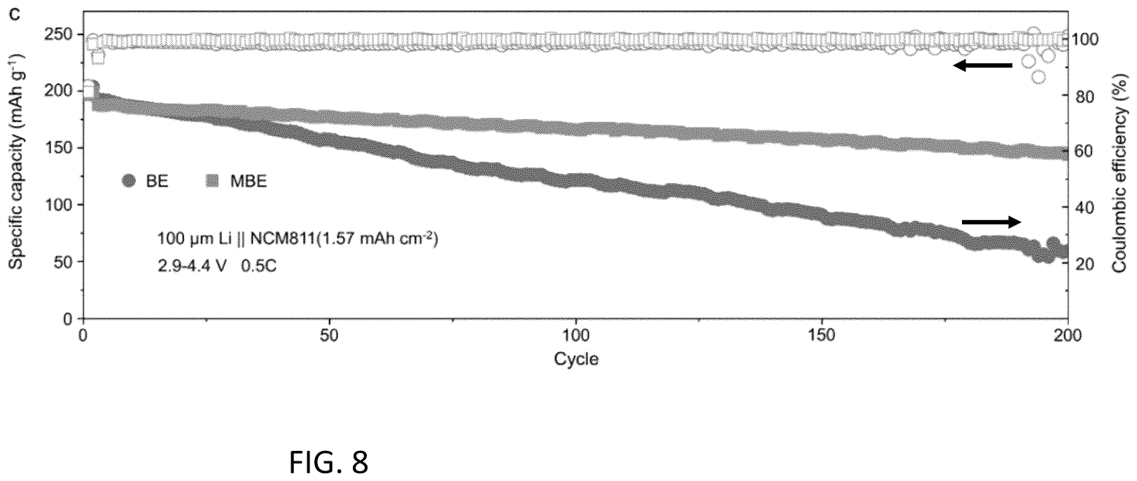

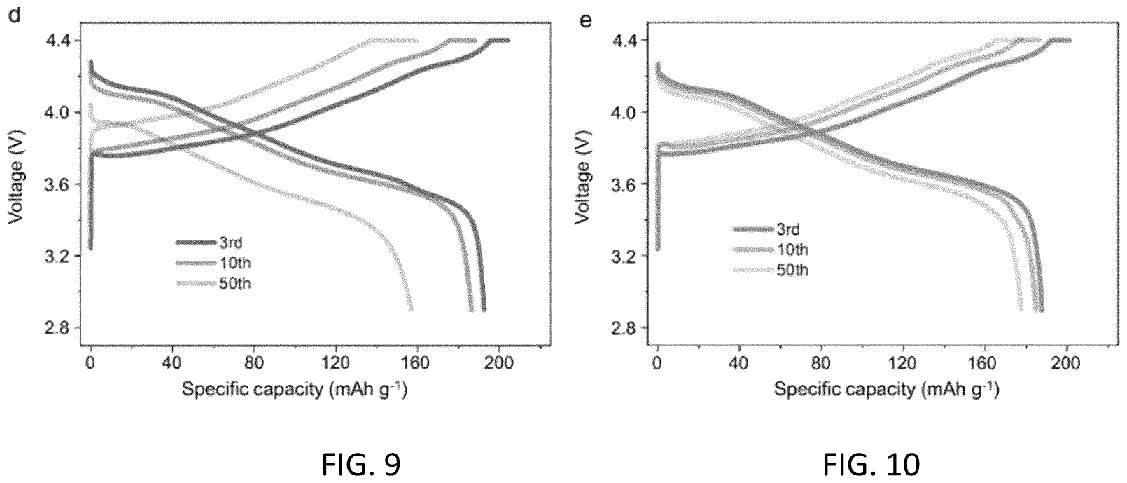

FIG. 8 shows cycling performance of a 100 μm Li∥NCM811 cell (1.57 mAh cm⁻²) at a current rate of 0.5 C, where initial two cycles were conducted at a current rate of 0.1 C for CEI and SEI formation. FIG. 9 shows charge-discharge voltage curves with the BE, and FIG. 10 shows charge-discharge voltage curves with the MBE. The cathode areal capacity was set to be 1.57 mAh cm⁻². As shown in FIGS. 8-10, the MBE significantly improved rechargeability, resulting in capacity retention of over 78% after 200 cycles, in contrast to 31% for the BE.

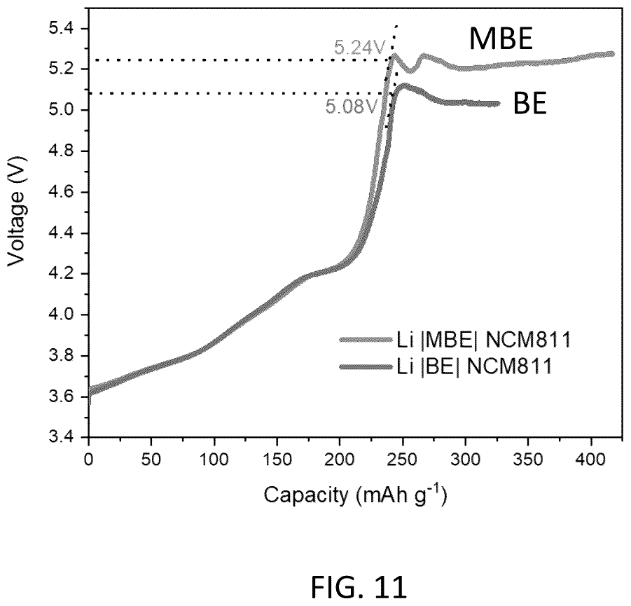

FIG. 11 shows charging voltage curves of the 100 μm Li∥NCM811 cell (1.57 mAh cm⁻²) when charging at a current density of 0.01 C. The cells underwent two preliminary cycles with a cut-off voltage of 4.4 V to facilitate the possible formation of CEI. In FIG. 11, the MBE exhibited a stable voltage against oxidation up to 5.24 V, surpassing the 5.08 V observed with the BE. This result suggests the possible presence of a more robust CEI formed using the MBE, capable of withstanding high voltage and suppressing oxidative decomposition of the electrolyte.

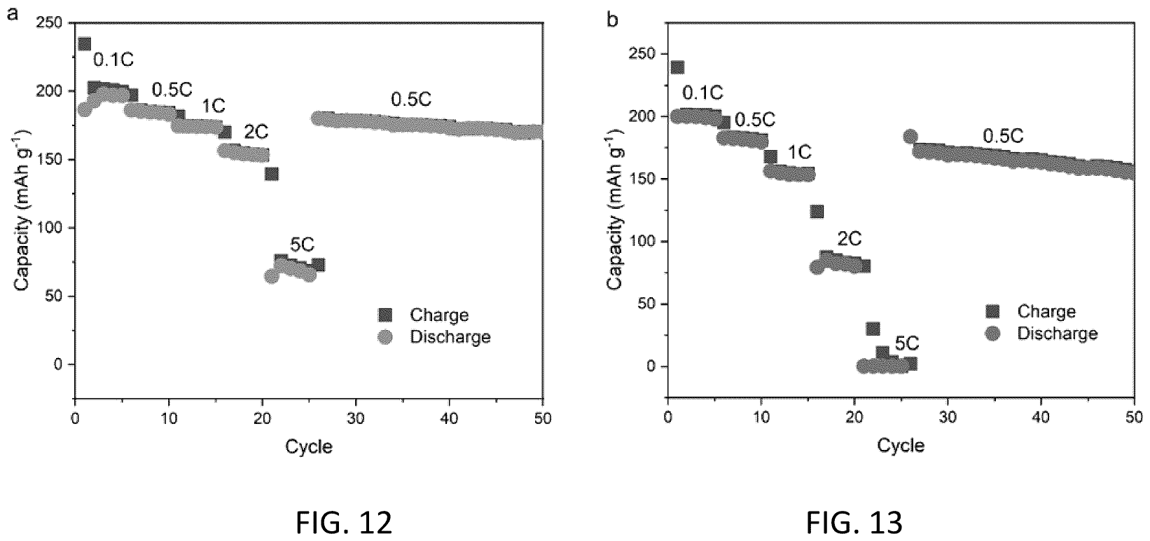

Furthermore, in cycling performance tests, the current rate was incrementally increased to 5 C to study the effect of the current rate. FIG. 12 shows rate performance with the MBE, and FIG. 13 shows rate performance with the BE. At 5 C, the cell with the BE exhibited negligible capacity (FIG. 13), while the cell with the MBE retained a capacity of approximately 70 mAh g⁻¹ (FIG. 12).

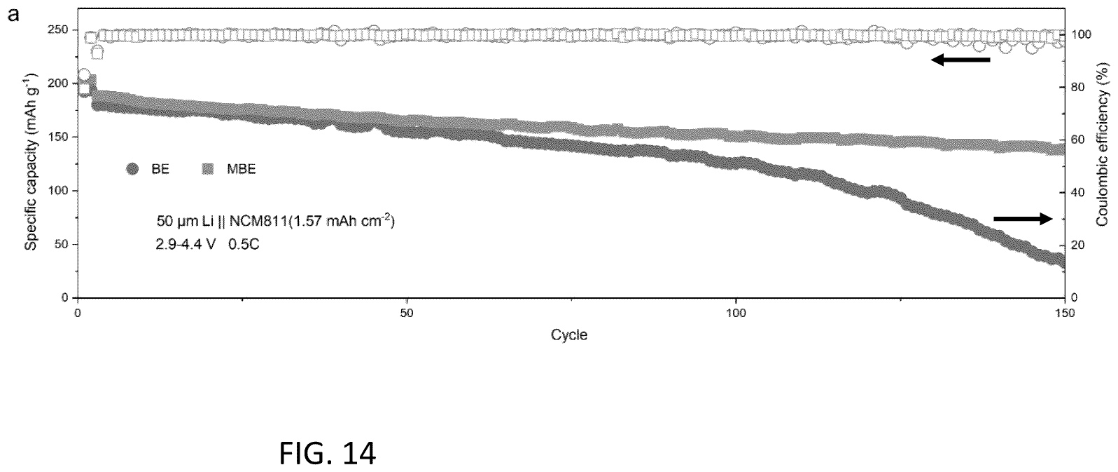

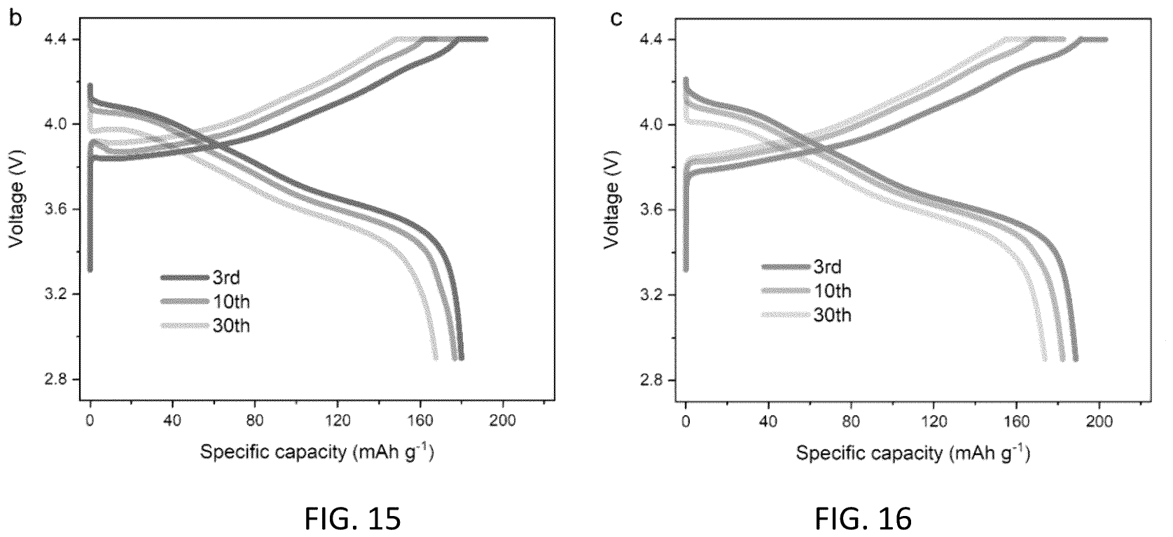

FIG. 14 shows cycling performance of a 50 μm Li∥NCM811 cell (1.57 mAh cm⁻²) at a current rate of 0.5 C, where initial two cycles were conducted at a current rate of 0.1 C for CEI and SEI formation. FIG. 15 shows charge-discharge voltage curves with the BE, and FIG. 16 shows charge-discharge voltage curves with the MBE. The cathode areal capacity was set to be 1.57 mAh cm⁻². As shown in FIGS. 14-16, similarly to the prior examples of the 100 μm Li∥NCM811 cell (FIGS. 8-10), the MBE exhibited improved stability in cycling performance. After 200 cycles, the disparity between the two electrolytes was more pronounced compared to the 100 μm Li∥NCM811 cell.

Example 3: Li-Ion Battery System

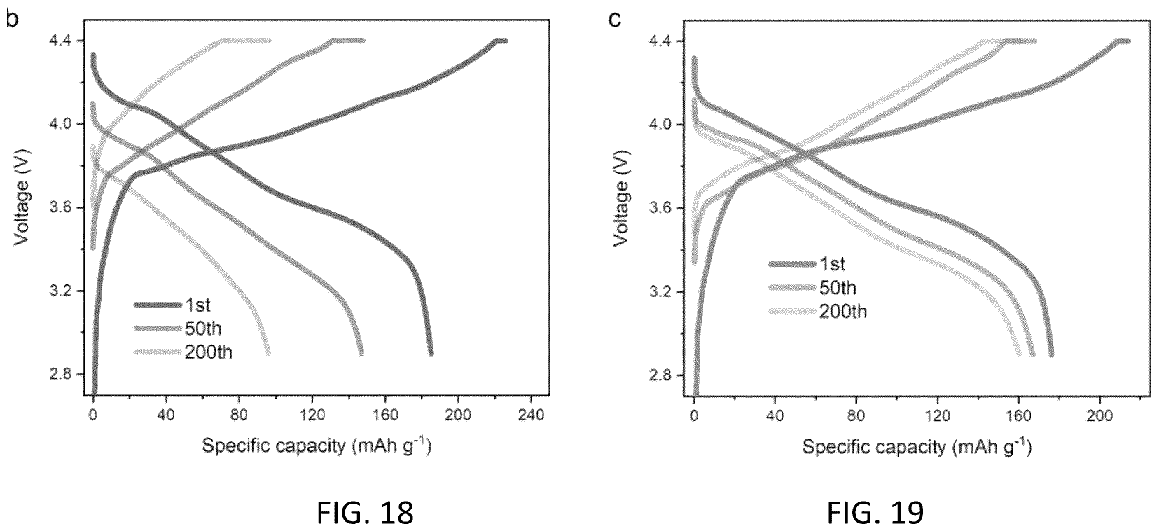

It was experimentally demonstrated that the polyvalent metal ion-containing electrolyte can improve battery performance not only in Li-metal battery system but also in Li-ion battery system. In these experiments, the same set of two electrolytes, BE and MBE, were used for the tests in a graphite∥NCM811 cell system. FIG. 17 shows cycling performance of a graphite∥NCM811 (1.57 mAh cm⁻²) (N/P ratio=1.28) cell at a current rate of 0.5 C. The initial two cycles were conducted at a current rate of 0.1 C for CEI and SEI formation. FIG. 18 shows charge-discharge voltage curves using the BE, and FIG. 19 shows charge-discharge voltage curves using the MBE. As shown in FIGS. 17-19, the MBE, magnesiated Li⁺ electrolyte, improved the stability of Coulombic efficiency (CE) over cycles. With the MBE, the cell retained 91% of its original capacity after 300 cycles, while the control cell with the BE sustained only 45% (FIG. 17).

### Example 4: Aluminum (Al³⁺) Ions

As described above, various polyvalent metal ions can be used as an additive for the Li-based electrolyte. An example of a non-magnesium ions was examined using Al(TFSI)₃. The Al-containing electrolyte, referred to as ABE, was prepared from the same benchmark electrolyte (BE) of the prior examples, by dissolving Al(TFSI)₃ in the BE to have 10 mM of Al³⁺ ions. FIG. 20 shows cycling performance of a 100 μm Li∥NCM811 cell (1.57 mAh cm⁻²) at a current rate of 0.5 C, where initial two cycles were conducted at a current rate of 0.1 C for CEI and SEI formation. FIG. 21 shows charge-discharge voltage curves with the ABE. Similarly to the prior examples of the magnesiated electrolyte, e.g., FIGS. 8-10, the ABE exhibited improved stability in cycling performance. While the CE gradually decreased over cycles using the ABE, the loss of CE was only about a half the loss of CE using the BE (FIG. 20).

### Implementations

An implementation described herein provides an electrochemical cell for a rechargeable battery, where the electrochemical cell includes: an anode including lithium (Li); an anode current collector connected to the anode; a cathode; a cathode current collector connected to the cathode; a separator between the anode and the cathode; and a liquid electrolyte including: a solvent, a Li salt dissolved in the solvent, and a polyvalent metal salt dissolved in the solvent.

In an aspect, combinable with any other aspect, the anode is a Li-metal anode.

In an aspect, combinable with any other aspect, the cathode includes Li and nickel (Ni).

In an aspect, combinable with any other aspect, the cathode includes LiNi_{0.8}Co_{0.1}Mn_{0.1}O₂ (NCM811).

In an aspect, combinable with any other aspect, the anode and the cathode are both Li metal.

In an aspect, combinable with any other aspect, the solvent includes a carbonate.

In an aspect, combinable with any other aspect, the solvent includes a mixture of ethylene carbonate and diethyl carbonate.

In an aspect, combinable with any other aspect, the Li salt is lithium hexafluorophosphate (LiPF₆).

In an aspect, combinable with any other aspect, a cation of the polyvalent metal salt includes magnesium (Mg²⁺), aluminum (Al³⁺), calcium (Ca²⁺), scandium (Sc³⁺), zinc (Zn²⁺), or gallium (Ga³⁺).

In an aspect, combinable with any other aspect, an anion of the polyvalent metal salt includes bis(trifluoromethanesulfonyl)imide.

In an aspect, combinable with any other aspect, a molar concentration of the Li salt in the liquid electrolyte is between 50 mM and 1 M.

In an aspect, combinable with any other aspect, a molar concentration of the polyvalent metal salt in the liquid electrolyte is between 2 mM and 0.5 M.

In an aspect, combinable with any other aspect, a molar ratio of the Li salt to the polyvalent metal salt is between 100:1 and 10:1.

In an aspect, combinable with any other aspect, the liquid electrolyte does not contain silicon.

Another implementation described herein provide a liquid electrolyte that includes: a solvent mixture including ethylene carbonate and diethyl carbonate; a lithium hexafluorophosphate (LiPF6) at a concentration of between 50 mM and 1 M; and a polyvalent metal salt at a concentration of 5 mM and 50 mM, wherein a cation of the polyvalent metal salt includes magnesium (Mg²⁺), aluminum (Al³⁺), calcium (Ca²⁺), scandium (Sc³⁺), zinc (Zn²⁺), or gallium (Ga³⁺), and wherein an anion of the polyvalent metal salt includes nitrogen and fluorine.

In an aspect, combinable with any other aspect, the polyvalent metal salt is magnesium bis(trifluoromethanesulfonyl)imide (Mg(TFSI)₂).

In an aspect, combinable with any other aspect, the liquid electrolyte does not contain silicon or ketone.

Another implementation described herein provides a lithium (Li)-metal rechargeable battery, including: a Li-metal anode; an anode current collector connected to the Li-metal anode; a cathode; a cathode current collector connected to the cathode; a separator between the Li-metal anode and the cathode; and a liquid electrolyte including, a solvent, a Li salt dissolved in the solvent, and a polyvalent metal salt dissolved in the solvent, where a metal cation of the polyvalent metal salt has Lewis acidity higher than a Li⁺ cation.

In an aspect, combinable with any other aspect, the metal cation is magnesium (Mg²⁺), aluminum (Al³⁺), calcium (Ca²⁺), scandium (Sc³⁺), zinc (Zn²⁺), or gallium (Ga³⁺), and wherein an anion of the polyvalent metal salt includes bis(trifluoromethanesulfonyl)imide.

In an aspect, combinable with any other aspect, the liquid electrolyte does not contain silicon or ketone.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

1. An electrochemical cell for a rechargeable battery, the electrochemical cell comprising:
an anode comprising lithium (Li);
an anode current collector connected to the anode;
a cathode;
a cathode current collector connected to the cathode;
a separator between the anode and the cathode; and
a liquid electrolyte comprising:
a solvent,
a Li salt dissolved in the solvent, and
a polyvalent metal salt dissolved in the solvent.

2. The electrochemical cell of claim 1, wherein the anode is a Li-metal anode.

3. The electrochemical cell of claim 1, wherein the cathode comprises Li and nickel (Ni).

4. The electrochemical cell of claim 1, wherein the cathode comprises LiNi_{0.8}Co_{0.1}Mno.₁O₂ (NCM811).

5. The electrochemical cell of claim 1, wherein the anode and the cathode are both Li metal.

6. The electrochemical cell of claim 1, wherein the solvent comprises a carbonate.

7. The electrochemical cell of claim 1, wherein the solvent comprises a mixture of ethylene carbonate and diethyl carbonate.

8. The electrochemical cell of claim 1, wherein the Li salt is lithium hexafluorophosphate (LiPF₆).

9. The electrochemical cell of claim 1, wherein a cation of the polyvalent metal salt comprises magnesium (Mg²⁺), aluminum (Al³⁺), calcium (Ca²⁺), scandium (Sc³⁺), zinc (Zn²⁺), or gallium (Ga³⁺).

10. The electrochemical cell of claim 1, wherein an anion of the polyvalent metal salt comprises bis(trifluoromethanesulfonyl)imide.

11. The electrochemical cell of claim 1, wherein a molar concentration of the Li salt in the liquid electrolyte is between 50 mM and 1 M.

12. The electrochemical cell of claim 1, wherein a molar concentration of the polyvalent metal salt in the liquid electrolyte is between 2 mM and 0.5 M.

13. The electrochemical cell of claim 1, wherein a molar ratio of the Li salt to the polyvalent metal salt is between 100:1 and 10:1.

14. The electrochemical cell of claim 1, wherein the liquid electrolyte does not contain silicon.

15. A liquid electrolyte, comprising:
a solvent mixture comprising ethylene carbonate and diethyl carbonate;
a lithium hexafluorophosphate (LiPF₆) at a concentration of between 50 mM and 1 M; and
a polyvalent metal salt at a concentration of 5 mM and 50 mM, wherein a cation of the polyvalent metal salt comprises magnesium (Mg²⁺), aluminum (Al³⁺), calcium (Ca²⁺), scandium (Sc³⁺), zinc (Zn²⁺), or gallium (Ga³⁺), and wherein an anion of the polyvalent metal salt comprises nitrogen and fluorine.

16. The liquid electrolyte of claim 15, wherein the polyvalent metal salt is magnesium bis(trifluoromethanesulfonyl)imide (Mg(TFSI)₂).

17. The liquid electrolyte of claim 15, wherein the liquid electrolyte does not contain silicon or ketone.

18. A lithium (Li)-metal rechargeable battery, comprising:
a Li-metal anode;
an anode current collector connected to the Li-metal anode;
a cathode;
a cathode current collector connected to the cathode;
a separator between the Li-metal anode and the cathode; and
a liquid electrolyte comprising,
a solvent,
a Li salt dissolved in the solvent, and
a polyvalent metal salt dissolved in the solvent, wherein a metal cation of the polyvalent metal salt has Lewis acidity higher than a Li cation.

19. The Li-metal rechargeable battery of claim 18, wherein the metal cation is magnesium (Mg²⁺), aluminum (Al³⁺), calcium (Ca²⁺), scandium (Sc³⁺), zinc (Zn²⁺), or gallium (Ga³⁺), and wherein an anion of the polyvalent metal salt comprises bis(trifluoromethanesulfonyl)imide.

20. The Li-metal rechargeable battery of claim 18, wherein the liquid electrolyte does not contain silicon or ketone.
